(19) United States
(12) Patent Application Publication
(10) Pub. No.: US 2009/0084831 A1
(43) Pub. Date: Apr. 2, 2009

(54) SOLDERING METHOD AND APPARATUS FOR MOUNTING DEVICES ON PRINTED CIRCUIT BOARD

(75) Inventors: Tetsuji Ishikawa, Kawasaki (JP); Osamu Saito, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 12/329,022

(22) Filed: Dec. 5, 2008

Related U.S. Application Data
(63) Continuation of application No. PCT/JP2006/315161, filed on Jul. 31, 2006.

(51) Int. Cl. B23K 31/02; B23K 3/04

(52) U.S. Cl. 228/199; 228/18

(57) ABSTRACT

In a case of soldering for mounting a device on a printed circuit board, a printed circuit board to which a device is soldered is heated in a high oxygen concentration atmosphere to form oxide films on surfaces of joints, by which detachment of a device soldered onto the surface of the printed circuit board, positional deviation, and rise from the printed circuit board at the time of reflow of the printed circuit board are prevented.

### CROSS-REFERENCE TO RELATED APPLICATION

This application is based upon and claims the benefit of priority of the prior International Patent Application No. PCT/JP2006/315161, filed on Jul. 31, 2006, the entire contents of which are incorporated herein by reference.

### FIELD

The embodiments discussed herein are directed to a soldering method and apparatus for mounting devices on a printed circuit board.

### BACKGROUND

Japanese Laid Open Patent Publication No. 2003-37357 describes to performing soldering in the ambient air atmosphere during main heating of reflow soldering so as to form an oxide film on the surface of a soldering portion and prevent devices from dropping off at the time of a second reflow soldering.

### SUMMARY

### Means

According to the first aspect, there is. provided a soldering method for soldering a device onto a printed circuit board, said soldering method having a step of soldering a device onto the printed circuit board and a step of heating the printed circuit board having the device soldered thereto in a high concentration oxygen atmosphere to form an oxide film on a surface of a solder joint of the device and the printed circuit board.

In the first aspect, preferably the soldering step heats the printed circuit board on which the device is mounted in a low concentration oxygen atmosphere.

Further, preferably the low concentration oxygen atmosphere is a nitrogen gas atmosphere.

According to the second aspect, there is provided a soldering apparatus for soldering a device onto a printed circuit board, the soldering apparatus comprises a first heating unit heating the printed circuit board on which a device is set under an inert gas atmosphere to solder the device and a second heating unit heating the soldered printed circuit board in a high concentration oxygen atmosphere.

In the second aspect, preferably a gas partition zone preventing mixing of the inert gas atmosphere and the high concentration oxygen atmosphere is further provided between the first heating unit and the second heating unit.

Further, preferably the gas is exhausted at the gas partition zone.

According to a third aspect, there is provided a method of production of a printed circuit board on which a device is mounted, the method of production of a printed circuit board having a step of soldering a device onto the printed circuit board in an inert gas atmosphere or low concentration oxygen atmosphere and a step of heating the printed circuit board after the device is soldered in a high concentration oxygen atmosphere to form an oxide film on the surface of a solder joint.

In the third aspect, preferably the low concentration oxygen atmosphere has an oxygen concentration of 2000 ppm or less.

In the third aspect, preferably the high concentration oxygen atmosphere has an oxygen concentration of 20% or more.

### BRIEF DESCRIPTION OF THE DRAWINGS

FIG. 1 is a cross-sectional view of a printed circuit board for explaining a conventional soldering method and apparatus for mounting devices on both surfaces of a printed circuit board;

FIGS. 2A to 2C are diagrams showing a lead wire and a solder wetting/spreading portion (fillet forming portion) coated on this lead wire;

FIG. 3 is a cross-sectional view of a printed circuit board for explaining a soldering method and apparatus for mounting devices on both surfaces of a printed circuit board according to an embodiment of the present invention;

FIG. 4 is a block diagram showing the constitution of a soldering apparatus (reflow soldering apparatus) for mounting devices on both surfaces of a printed circuit board according to Example 1 of the present invention;

FIG. 5 is a flow chart for explaining a reflow soldering process by a reflow soldering apparatus 40 shown in FIG. 4;

FIG. 6 is a block diagram showing the constitution of a soldering apparatus (reflow soldering apparatus) for mounting devices on both surfaces of a printed circuit board according to Example 2 of the present invention;

FIG. 7 is a flow chart for explaining a reflow soldering process by a reflow soldering apparatus 60 and a pipe 61 shown in FIG. 6;

FIG. 8 is a diagram showing a situation of an oxide film being formed at a fillet portion in Example 1 or 2 of the present invention; and

FIG. 9 is a graph showing relationships between the heating temperature and oxygen concentration of the printed circuit board and a thickness of a formed oxide film.

### DESCRIPTION OF EMBODIMENTS

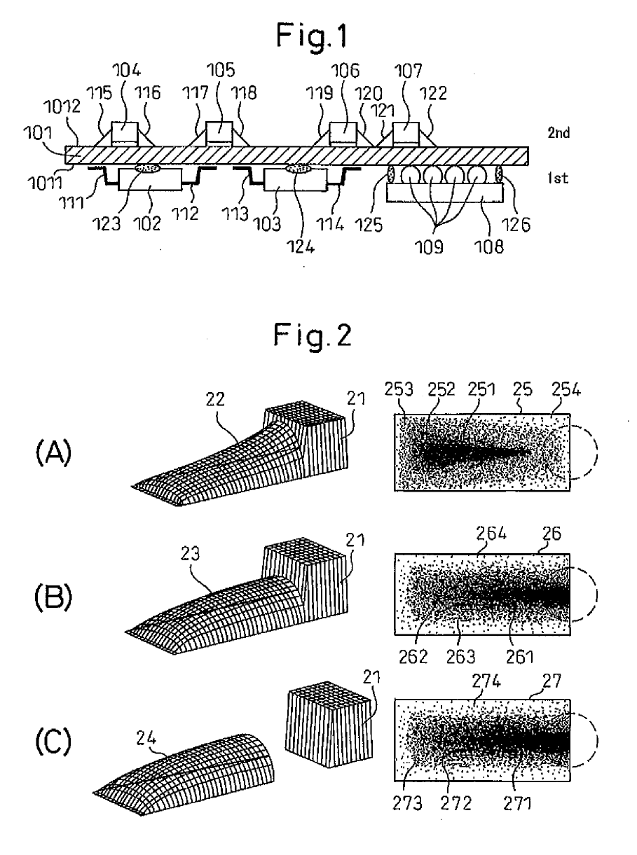

FIG. 1 is a cross-sectional view of a printed circuit board for explaining conventional soldering method and apparatus for mounting devices on both surfaces of a printed circuit board. In FIG. 1, 101 is a printed circuit board (PCB) on which solder is coated in advance on required portions of both surfaces, 102 to 107 are devices connected to solder joints including lead wires by reflow soldering, 108 is BGA (Ball Grid Array), 109 is a bump formed by a mass of solder, 111 to 122 are solder joints including lead wires, 123 to 126 are binders, 1011 is a first surface of the PCB 101, and 1012 is a second surface of the PCB 101. As devices, there are large sized IC or modules and other heavy weight devices.

In the conventional reflow soldering process, generally, (1) solder paste is printed on the PCB, (2) a binder is coated on the PCB, (3) the devices are mounted on the PCB, (4) the solder is made to reflow, and (5)the exterior is automatically inspected. In a first reflow, devices are attached to the first surface 1011 of the PCB and the steps of (1), (2), (3), and (4) among these are carried out. In a second reflow, devices are attached to the second surface 1012 of the PCB continuing from the attachment of devices to the first surface 1011, and the steps of (1), (3), and (4) are carried out. Next, after the devices are attached to the PCB, the step of (5) is carried out for both surfaces all together. The finished printed circuit board becomes as shown in FIG. 1.

In the step of the reflow soldering of (4). described above, the reflow heating device performs two-step heating in a preheating zone of 120 to 160° C. and a main heating zone of 205 to 235° C. In that case, it is necessary to secure a good solder wetting/spread (fillet formation) to conductor portions of the printed circuit board and electrode portions of devices for securing the reliability of the joints. Further, for good fillet formation and for maintaining precision of detection in the automatic inspection of the exterior, it is necessary to solder by an inert gas atmosphere (oxygen concentration of 2000 PPM or less) using nitrogen gas etc.

In a two-surface mounting printed circuit board (PCB), the devices are soldered on each surface of the substrate by reflow. Namely, the first surface 1011 of the PCB 101 is directed upward first so that solder joints 111, 112, 113, and 114 connected to the devices are soldered onto the first surface 1011 of the PCB 101 by reflow. After that, the first surface 1011 is directed downward as illustrated and the second surface 1012 of the PCB 101 is directed upward so that solder joints 115 to 122 of the devices 104 to 107 are soldered onto the second surface 1012 of the PCB 101 by the second reflow. By the reheating at the time of this second reflow, the solder of the solder joints fixing the devices attached by the first reflow melts. There is a problem that the devices 102 and 103 fall off during the second reflow when the weights of the devices 102 and 103 soldered by the solder joints 111 to 114 to the first surface 1011 of the PCB 101 by the first reflow exceed the surface tension of melted solder in the solder joints 111 to 114. In the same way, there is a problem that the bumps 109 of the masses of solder between the BGA 108 and the printed circuit board 101 melt during the second reflow, so the device 108 falls off during the second reflow when the weight of the device 108 exceeds the surface tension of the melted solder of the bumps 109.

Conventionally, for preventing these devices from falling off at the time of the second reflow, the processes of coating binder 123 to 126 at positions of the PCB 101 corresponding to the bottoms of the devices 102, 103, and 108 (between the devices 102, 103, and 108 and the PCB 101 in the illustration) attached to the PCB 101 by the first reflow are increased whereby the devices 102, 103, and 108 are fixed onto the PCB 101 by the binder 123 to 126.

In recent years, BGA (Ball Grid Array) shaped devices having electrodes over the entire back surface of the body are increasing. Further, the boards on which devices are mounted are becoming higher in density and narrower in pitch of space between devices, therefore, it is becoming difficult to secure a binder coating space.

Further, the process is increased by one step for the binder coating, therefore the production cost of the printed circuit board rises. Further, at the time of reworking for exchanging devices once mounted on the substrate due to problems with the devices and the like, it is necessary to melt the solder. However, the binder cannot be re-melted, therefore it becomes difficult to perform the reworking. There is no method of exchanging the devices except for shaving off the binder. For this reason, there was the problem that expensive printed circuit boards had to be discard.

Further, as disclosed in Japanese Laid Open Patent Publication No. 2003-37357, in the technique of forming an oxide film by soldering in an air atmosphere at the time of the main heating, the electric connection parts between the solder joints and devices are oxidized, therefore the wetting property of the solder becomes worse. Further, due to the degradation of the wetting property of the solder, even if electric connections between the solder joints and devices have been established, the ratio of erroneous judgments of there being problems with lead wire rising up at the time of the external inspection increases. This point will be explained in detail according to FIGS. 2A to 2C.

FIGS. 2A to 2C are diagrams showing a solder joint including a lead wire and a solder wetting/spreading portion (fillet forming portion) coated on this lead wire. In FIG. 2, 21 is a lead wire, 22 to 24 are fillet formation portions, 25 to 27 are diagrams showing degrees of inclination of the fillet forming portions by the automatic external inspection for inspecting the three-dimensional structure of the fillet by a color light method. In the color light method, a portion having a large inclination is indicated by for example a blue color and a flat portion having little inclination is indicated by for example a red color.

In the three-dimensional structure 25 of the fillet 22 of FIG. 2A, 251 is a red color portion showing a flat portion of the fillet 22, 252 is a yellow color portion showing a slightly inclined portion of the fillet 22, 253 is a green color portion of the fillet 22 in which the degree of inclination further becomes larger, and 254 is a blue color portion showing the largest inclined portion of the fillet 22.

In the three-dimensional structure 26 of the fillet 23 of FIG. 2B, 261 is a red color portion showing a flat portion of the fillet 23, 262 is a yellow color portion showing a slightly inclined portion of the fillet 23, 263 is a green color portion of the fillet 23 in which the degree of inclination further becomes larger, and 264 is a blue color portion showing the largest inclined portion of the fillet 23.

In the three-dimensional structure 27 of the fillet 24 of FIG. 2C, 271 is a red color portion showing a flat portion of the fillet 24, 272 is a yellow color portion showing a slightly inclined portion of the fillet 24, 273 is a green color portion of the fillet 24 in which the degree of inclination further becomes larger, and 274 is a blue color portion showing the largest inclined portion of the fillet 24.

The lead wire 21 is for example a portion contacting the printed circuit board 101 of an L-type solder joint 111 in FIG. 1. The fillets 22 to 24 are solder connecting this lead wire 21 and interconnects on the printed circuit board.

FIG. 2A is a diagram showing a situation where the fillet 22 of the solder is connected to the lead wire 21 well. In this case, in the automatic external inspection, as shown on the right side of FIG. 2A, the inclination of the portion indicated by a broken line circle contacting the lead wire 21 of the illustrated right side portion of the fillet 22 of the solder is shown largely. It is seen that good soldering has been performed.

Contrary to this, in a case where the soldering is carried out in the air atmosphere, as shown in FIG. 2B, there is a possibility that the reliability of the soldering will be influenced, for example the wetting/spreading property of the solder will become poor. Further, it is judged that the inclination of the portion where the fillet 23 and the lead wire 21 contact shown at 26 of FIG. 2B is small and flat. Therefore, even if the connection between the fillet 23 and the lead wire 21 has been established, the possibility of erroneous judgment that there is a problem of the lead wire rising up or there is another connection failure becomes high.

On the other hand, in the example of FIG. 2C, the fillet 24 and the lead wire 21 are not connected to each other. Here, when judging the fillet shape by the automatic external inspection, an inspection result as shown in 27 of FIG. 2C is obtained. However, it is hard to distinguish 26 of the inspection result of FIG. 2B and 27 of the inspection result of FIG. 2C from each other. For this reason, in order to reliably judge the state of FIG. 2C as defective connection, the state of FIG. 2B cannot help being erroneously judged as defective connection also.

In this way, in the technique for soldering in the ambient air atmosphere disposed in Japanese Laid-Open Patent Publication No. 2003-37357, the reliability of the solder joint is poor and the inspection precision becomes worse. Here, when the state of FIG. 2B is judged as a good product in the automatic external inspection, this is liable to lead to quick disconnection of the solder joint or a serious accident due to inspection error. For this reason, the state of FIG. 2B is judged as a product defect. However, in actuality, it is judged as the product defect irrespective of being a good product in which the electric connection between the fillet 22 and the lead wire 23 is established (false report rate becomes high) and the number of final confirmation steps executed by the human eye for the true inspection of defects increases. In a communication apparatus or other equipment in which a high reliability is required, it is essential to secure the solder wetting/spreading property and precision of detection of problems parts of the solder joints. However, there is the problem that the technique disclosed in Japanese Laid-Open Patent Publication No. 2003-37357 cannot secure these.

An object of the present embodiment is, in consideration with the problems in the prior art described above, to provide a soldering method and apparatus for mounting devices on both surfaces of a printed circuit board wherein an oxide film is formed on the solder joints after the soldering of devices whereby detachment of heavy weight devices, positional deviation of devices, and rising up from the board are eliminated and high quality and high inspection precision are enabled.

Embodiments will be explained in detail below according to the drawings.

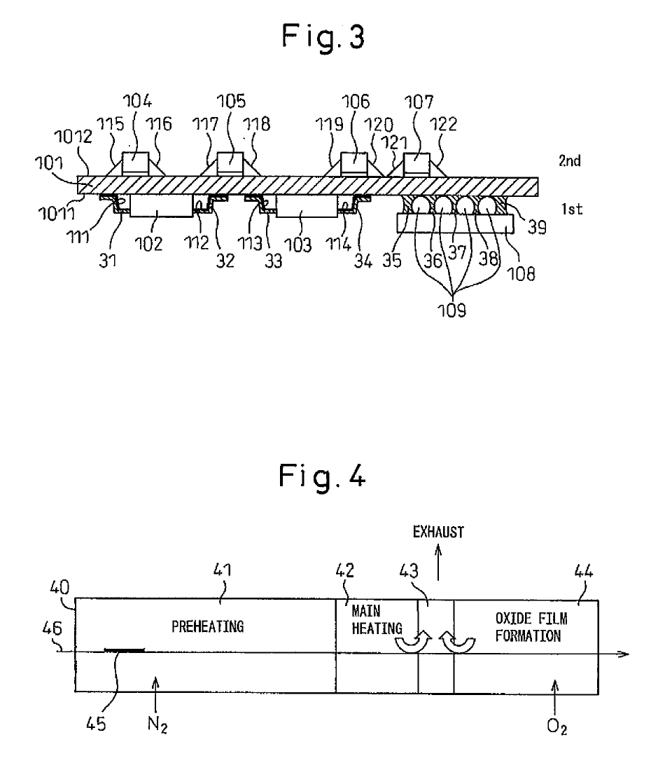

FIG. 3 is a cross-sectional view of a printed circuit board for explaining the soldering method and apparatus mounting devices on both surfaces of the printed circuit board according to the embodiment. In FIG. 3, the same reference numerals are attached to the same portions as those in FIG. 1, and explanations are omitted. In FIG. 3, the different portions from those of FIG. 1 are that the binders 102, 102, 125, and 126 shown in FIG. 1 do not exist and that the solder joints 111, 112, 113, and 114 including the lead wires and the part from the tops of the bump 109 of the masses of solder to the surface of the PCB 101 are covered by the oxide films 31, 32, 33, 34, 35, 36, 37, and 39. By covering the solder joints and bump by these oxide films, even at the time of the second reflow, the detachment and positional deviation of the devices 102, 103, and 109 and the rise of the lead wires from the board can be prevented.

### EXAMPLE 1

FIG. 4 is a block diagram showing the constitution of the soldering apparatus (reflow soldering apparatus) for mounting devices on both surfaces of a printed circuit board according to Example 1. In FIG. 4, 40 is a reflow soldering apparatus, 41 is a preheating unit for preheating at 120 to 150° C., 42 is a main heating unit for soldering devices onto the substrate by heating the solder at 205 to 235° C., 43 is a gas partition zone, 44 is an oxide film formation zone, 45 is a printed circuit board, and 46 is a belt conveyer for conveying the printed circuit board 45.

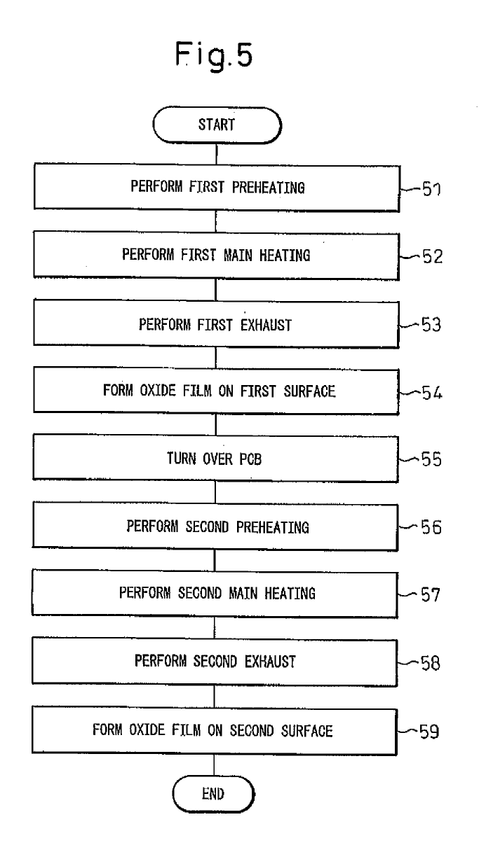

FIG. 5 is a flow chart for explaining the reflow soldering process by the reflow soldering apparatus 40 shown in FIG. 4. In FIG. 5, at step 41, the printed circuit board 35 is preheated the first time by the preheating unit 31 in a nitrogen gas atmosphere to a temperature before melting the solder of 120 to 150° C. Next, at step 52, the printed circuit board 45 conveyed by the belt conveyer 46 is heated the first time by the main heating unit 42 in a nitrogen gas atmosphere to a temperature of melting the solder of 205 to 235° C. whereby the solder joints of the devices are soldered to interconnects of the printed circuit board. Next, at step 53, the nitrogen gas is exhausted at the gas partition zone 43. Next, at step 54, in the oxide film formation zone 44, the printed circuit board is maintained in an atmosphere having an oxygen concentration of about 60 to 80% and a temperature of 150° C. or more for a time of 30 to 210 seconds to thereby to form an oxide film on the solder joints including the lead wires of devices and fillet portions mounted on the first surface of the printed circuit board.

As the nitrogen gas in the preheating unit 41 and the main heating unit 42, use can be made of, for example, an inert gas atmosphere obtained by filling nitrogen. The oxygen concentration in this case is preferably about 100 to 2000 ppm. The gas used in the preheating and the main heating may be another inert gas in place of nitrogen as well, and the oxygen concentration may be lower than the oxygen concentration of the ambient air atmosphere.

At an inlet of the printed circuit board 45 of the preheating unit 41, an outlet of the printed circuit board 45 on a border between the main heating unit 42 and the gas partition zone 43, and an inlet and outlet of the printed circuit board 45 of the oxide film formation zone 44, soft curtain-like materials are provided in order to avoid outflow of the gas as much as possible, whereby a labyrinth effect is given,

In the oxide film formation zone 44, high concentration oxygen gas is produced and filled from liquid oxygen, polyimide hollow filament film, etc. or is obtained by introducing 20 to 100% of liquid oxygen and controlling the system to an oxygen concentration of about 60 to 80%.

The gas partition zone 43 is provided between the main heating unit 42 and the oxide film formation zone 44. The gas partition zone 33 is exhausted, therefore mixing of the nitrogen filled in the main heating unit 42 and the oxygen filled in the oxide film formation zone 44 is prevented. By providing such a gas partition zone 43, the mixing of the high concentration oxygen into the preheating unit 41 and main heating unit 42 is prevented, therefore the wetting property of the soldering becomes good, and a probability of false report in the automatic external inspection (judgment as a product defect irrespective of being a good product) becomes small.

After the end of the processing of step 54, at step 55, the printed circuit board PCB is turned over to prepare for the second reflow soldering. Next, the second preheating is carried out at step 56, the second main heating is carried out at step 57, the second exhaust is carried out at step 58, and the oxide film is formed on the second surface at step 59. At steps 56 to 59, the same steps as steps 51 to 54 are carried out on the second surface 1012 of the printed circuit board, therefore a detailed explanation is omitted here. For the second surface 1012, the formation of the oxide film carried out at step 59 may be omitted.

### EXAMPLE 2

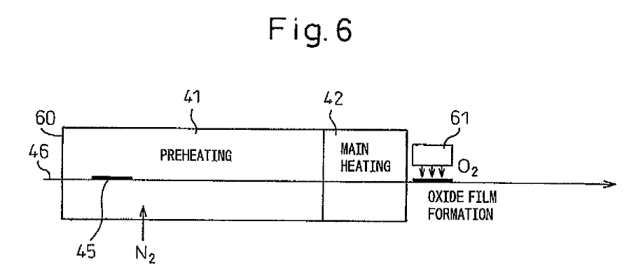

FIG. 6 is a block diagram showing the constitution of a soldering apparatus (reflow soldering apparatus) for mounting devices on both surfaces of a printed circuit board according to Example 2. In FIG. 6, the same reference numerals are attached to the same portions as those of FIG. 4. Example 2 is an example enabling easy formation of an oxide film on a fillet by using equipment which conventionally exists. In FIG. 6, 60 is a reflow soldering apparatus, 41 is a preheating unit for preheating at 120 to 150° C., 42 is a main heating unit for soldering at 205 to 235° C., 45 is a printed circuit board, 46 is a belt conveyer for conveying the printed circuit board 45, and 61 is a pipe for spraying high concentration oxygen to the printed circuit board after the soldering.

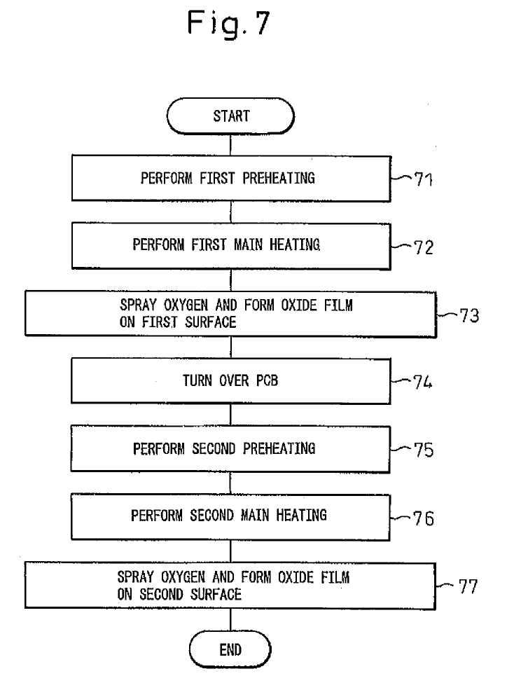

FIG. 7 is a flow chart explaining the reflow soldering process by the reflow soldering apparatus 60 and pipe 61 shown in FIG. 6. In FIG. 7, at step 71, the printed circuit board 45 is preheated by the preheating unit 41 in a nitrogen gas atmosphere to a temperature before the solder melts, that is, 120 to 150°C. Next, at step 72, the printed circuit board 45 is heated by the main heating unit 42 in a nitrogen gas atmosphere to the solder melting temperature of 205 to 235° C., whereby the solder joints including the lead wires of devices and fillet portions are soldered to the interconnects of the printed circuit board.

Next, at step 73, high concentration oxygen is directly sprayed from the pipe 51 to the printed circuit board 45 leaving the reflow soldering apparatus 60 so as to form an oxide film on the fillet portions formed on the printed circuit board. Here, the temperature at the outlet of the reflow soldering apparatus 60 is 150 to 170° C., therefore the remaining heat is utilized for the formation of the oxide film onto the fillet portions. In that case, when the temperature of the oxygen gas sprayed to the printed circuit board is too high, there is a possibility that the solder will melt and the devices will be blown off from the printed circuit board by the oxygen gas. In order to prevent such blow off of devices from the printed circuit board, the temperature of the oxygen gas ejected from the pipe 61 is made lower than the melting point of the solder, that is, about 170° C. Further, the oxygen concentration of the oxygen gas is 85% or more.

In Example 2 as well, as the nitrogen gas in the preheating unit 41 and main heating unit 42, for example, there is an atmosphere having an oxygen concentration of 100 to 2000 ppm obtained by filling nitrogen. In the preheating and main heating, the nitrogen may be replaced by another inert gas as well. The oxygen concentration may be lower than the oxygen concentration of the air atmosphere.

After the end of the processing of step 73, at step 74, the printed circuit board PCB is turned over to prepare for the second reflow soldering. Next, at step 75, the second preheating is carried out, at step 76, the second time main heating is carried out, and at step 77, the oxygen is sprayed to the second surface to form the oxide film. At steps 75 to 77, the same steps as steps 71 to 73 are carried out With respect to the second surface of the printed circuit board, therefore a detailed explanation is omitted here. In Example 2 as well, for the second surface, the formation of the oxide film carried out at step 77 may be omitted.

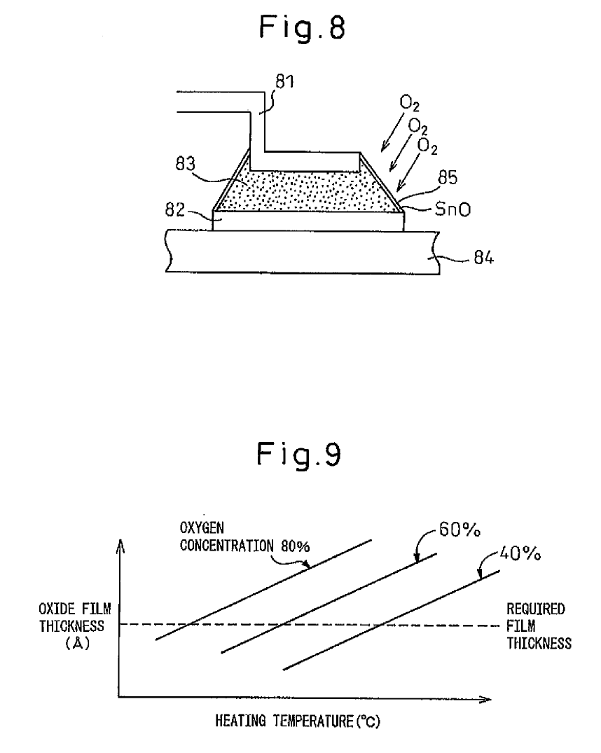

FIG. 8 is a diagram showing a state where the oxide film is formed on the fillet portions in Example 1 or 2 of the present invention. In FIG. 8, 81 is the lead wire of a device, 82 is a copper pattern for interconnects formed on the printed circuit board, 83 is a fillet portion formed by reflow, and 84 is a glass epoxy substrate constituting the lower portion of the printed circuit board. According to Example 1 or 2 of the present invention, the oxide film 75 is formed so as to cover the fillet portion 73. By the effect of increasing the surface tension of the melted paste and the effect of lowering the fluidity by this oxide film, the detachment of devices soldered to the printed circuit board by the first reflow, separation of these from the substrate, and the positional deviation at the time of the second reflow are prevented.

FIG. 9 is a graph showing the relationships between the heating temperature and oxygen concentration of a printed circuit board and the thickness of the formed oxide film. The thickness of the oxide film is managed in accordance with the weight of the devices mounted on the printed circuit board. Namely, there is an interrelationship between the thickness of the oxide film and the weight of devices up to which the oxide film can prevent detachment, therefore the required thickness of the oxide film to be formed is determined in advance from the greatest weight of the devices mounted on the printed circuit board for reflow. As seen from FIG. 9, in the case of the same oxygen concentration, the higher the heating temperature, the greatest the film thickness of the produced oxide film. Further, when obtaining an oxide film having the same film pressure, the higher the oxygen concentration, the lower the heating temperature possible. The relationships of the oxide film thickness-heating temperature/oxygen concentration shown in FIG. 9 are found in advance, and conditions for obtaining the required oxide film pressure are derived from the found relationships

As described above, when forming an oxide film on the fillets according to Example 1 or 2 of the present invention, the surface of the oxide film loses its gloss and becomes white at the time of the external inspection. However, the physical three-dimensional shape of the fillets does not change so much from the shape of the fillets formed in the conventional low oxygen atmosphere. Therefore, by changing the settings of the parameters of the external inspection apparatus, external inspection is possible.

Further, in Example 1 or 2 of the present invention, no binder is interposed between devices and the printed circuit board, therefore reworking for exchanging devices can be easily carried out in the same way as the case where there is no binder since the oxide film is easily destroyed at the time of the solder melting.

Further, the influence of oxidation of the substrate surface at the time of the first reflow upon the second reflow is lost in a case of the current mainstream surface treatment by an organic coating film (heat resistant pre-lacquer) or an inorganic coating film (solder leveler substrate).

According to the present embodiment, by the formation of the oxide film on the surface of the solder joints in a high oxygen concentration atmosphere, the strength of the melted paste fixing the devices in place can be increased by the effect of increase of the surface tension and action in lowering the fluidity by the oxide film, therefore the detachment of heavy weight devices, the positional deviation of devices, and the rising of solder joints from the printed circuit board can be prevented cheaply and efficiently without using a binder.

Further, according to the present embodiment, there are provided a soldering method and apparatus soldering a device in a low oxygen atmosphere before the formation of the oxide film so as to mount a device on the printed circuit board able to maintain the reliability of soldering and precision of inspection by an automatic external inspection.

### INDUSTRIAL CAPABILITY

According to the present invention, in the soldering method and apparatus for mounting devices on both surfaces of a printed circuit board, by employing the constitution for forming an oxide film on the surface of devices after attachment of devices to the printed circuit board, the detachment of heavy weight devices, positional deviation of devices, and rise of the solder joints can be prevented cheaply and efficiently without a binder.

What is claimed is:

1. A soldering method soldering a device onto a printed circuit board, comprising the steps of:
soldering a device onto a printed circuit board; and
heating a printed circuit board to which the device is soldered in a high concentration oxygen atmosphere to form an oxide film on a surface of a solder joint of the device and the printed circuit board.

2. A soldering method as set forth in claim 1, wherein the soldering step heats the printed circuit board on which the device is mounted in a low concentration oxygen atmosphere.

3. A soldering method as set forth in claim 2, wherein the low concentration oxygen atmosphere is a nitrogen gas atmosphere.

4. A soldering apparatus for soldering a device onto a printed circuit board, comprising:
a first heating unit heating the printed circuit board on which a device is disposed under an inert gas atmosphere to solder the device; and
a second heating unit heating the soldered printed circuit board in a high concentration oxygen atmosphere.

5. A soldering apparatus as set forth in claim 4, wherein a gas partition zone preventing mixing of the inert gas atmosphere and the high concentration oxygen atmosphere is further provided between the first heating unit and the second heating unit.

6. A soldering apparatus as set forth in claim 5, wherein the gas is exhausted at the gas partition zone.

7. A production method of a printed circuit board on which a device is mounted, comprising the steps of:
soldering a device onto the printed circuit board in an inert gas atmosphere or a low concentration oxygen atmosphere; and
heating the printed circuit board after the device is soldered in a high concentration oxygen atmosphere to form an oxide film on the surface of a solder joint.

8. A production method of a printed circuit board as set forth in claim 7, wherein the low concentration oxygen atmosphere has an oxygen concentration of 2000 ppm or less.

9. A production method of a printed circuit board as set forth in claim 7, wherein the high concentration oxygen atmosphere has an oxygen concentration of 20% or more.
